(19) United States
(12) Patent Application Publication
(10) Pub. No.: US 2018/0373856 A1
(43) Pub. Date: Dec. 27, 2018

(54) WEARABLE DEVICE AND METHOD OF IDENTIFYING BIOLOGICAL FEATURES

(71) Applicant: BOE TECHNOLOGY GROUP CO., LTD., Beijing (CN)

(72) Inventors: Xiaodong SHI, Beijing (CN); Miao LIU, Beijing (CN); Bin ZOU, Beijing (CN)

(21) Appl. No.: 15/741,419

(22) PCT Filed: May 10, 2017
(86) PCT No.: PCT/CN2017/083707

§ 371 Date: Jan. 2, 2018

(30) Foreign Application Priority Data
May 16, 2016 (CN) 201610324320.1

(51) Int. Cl. G06F 21/32; G06F 1/16; G06Q 20/32; G06Q 20/40

(52) U.S. Cl. CPC G06F 21/32; G06F 1/163; G06Q 20/40145; G06Q 20/327; G06F 1/1635

(57) ABSTRACT

This application provides a wearable device and an information processing method. The wearable device includes a biometric image acquiring unit configured to acquire a biometric image of predetermined biological features of a user; a feature information extracting unit configured to perform predetermined image processing on the acquired biometric image to extract feature information of predetermined biological features of the user; and an identifying unit configured to compare the extracted feature information of predetermined biological features of the user with pre-stored feature information to identify whether the user is an authorized user.

### TECHNICAL FIELD

The present application relates to a wearable device and a method of identifying biological features.

### BACKGROUND

At present, wearable smart electronic products are being widely used, they provide the user with increasingly enriched functions, and greatly change the user's lifestyle. On the other hand, along with the rapid development of information technology, offline payment becomes more and more convenient, which also puts forward new higher requirements on offline smart payment. Payment safety of the current smart wearable devices is not high, and account balance bound to the devices can be easily stolen in the case of being lost. In addition, due to poor safety performance, the current smart wearable devices do not have authority to perform large payment, and devices having the capacity of performing large payment are relatively cumbersome and unwearable. So how to achieve safe, reliable large payment and easy portability has become a key issue that must be solved by smart payment.

To this end, it is desirable to provide a wearable device and a method of identifying biological features that enable safe, reliable payment while realizing easy and convenient portability.

### SUMMARY

According to an embodiment of the present application, there is provided a wearable device, comprising:

a biometric image acquiring unit configured to acquire a biometric image of predetermined biological features of a user;

a feature information extracting unit configured to perform predetermined image processing on the acquired biometric image to extract feature information of predetermined biological features of the user; and

an identifying unit configured to compare the extracted feature information of predetermined biological features of the user with pre-stored feature information to identify whether the user is an authorized user.

Optionally, the predetermined biological features at least include finger vein information of the user, and the biometric image acquiring unit is configured to acquire a finger vein image of a predetermined finger of the user.

Optionally, the biometric image acquiring unit further comprises:

an accommodating sub-unit configured to accommodate a predetermined finger of the user;

an infrared light source sub-unit configured to emit infrared light to illuminate the predetermined finger of the user as accommodated in the accommodating sub-unit; and

an image sensor sub-unit configured to receive infrared light that has illuminated the predetermined finger of the user and passed through, thereby generate a finger vein image of the predetermined finger of the user.

Optionally, the infrared light source sub-unit is disposed on a first side in a horizontal direction of the accommodating sub-unit, and the image sensor sub-unit is disposed on a second side opposite to the first side in a horizontal direction of the accommodating sub-unit.

Optionally, a size of the accommodating sub-unit is configured to have a predetermined depth and a predetermined width suitable for the user's finger, detect a shape of the accommodated predetermined finger of the user, and adjust the predetermined depth and the predetermined width according to the shape detected for the predetermined finger of the user.

Optionally, the wearable device further comprises:

a payment unit configured to perform a payment transaction operation according to a predetermined operation when the user is identified as an authorized user.

Optionally, the wearable device further comprises:

a fitness step counting unit configured to acquire step count and sleep information of the user; and

a display unit configured to display step count and sleep information acquired by the fitness step counting unit.

Optionally, the wearable device further comprises:

a communication unit configured to communicate with an external electronic device in accordance with a predetermined communication protocol, so as to transfer the acquired step count and sleep information to the external electronic device, thus realizing information synchronization.

Optionally, the wearable device further comprises:

a securing unit configured to secure relative positional relationship between the electronic device and the user; and

a power source unit configured to include a flexible battery and be integrated into the securing unit.

According to another embodiment of the present application, there is provided an information processing method applicable to a wearable device, the method comprising:

acquiring a biometric image of predetermined biological features of a user;

performing predetermined image processing on the acquired biometric image to extract feature information of predetermined biological features of the user; and

comparing the extracted feature information of predetermined biological features of the user with pre-stored feature information to identify whether the user is an authorized user.

Optionally, the predetermined biological features are fingers of the user, and acquiring a biometric image of predetermined biological features of a user further comprises acquiring a finger vein image of a predetermined finger of the user.

Optionally, acquiring a finger vein image of a predetermined finger of the user further comprises:

accommodating a predetermined finger of the user via an accommodating sub-unit of the wearable device;

emitting infrared light via an infrared light source sub-unit of the wearable device to illuminate the predetermined finger of the user as accommodated in the accommodating sub-unit; and

receiving infrared light that has illuminated the predetermined finger of the user and passed through, thereby generating a finger vein image of the predetermined finger of the user via an image sensor sub-unit of the wearable sub-unit.

Optionally, the infrared light source sub-unit is disposed on a first side in a horizontal direction of the accommodating sub-unit and the image sensor sub-unit is disposed on a second side opposite to the first side in a horizontal direction of the accommodating sub-unit.

Optionally, a size of the accommodating sub-unit is configured to have a predetermined depth and a predetermined width suitable for the user's finger.

Optionally, the method further comprises:

detecting a shape of the accommodated predetermined finger of the user; and

adjusting the predetermined depth and the predetermined width according to the shape detected for the predetermined finger of the user.

Optionally, the method further comprises:

performing a payment transaction operation according to a predetermined operation when the user is identified as an authorized user.

Optionally, the wearable device further comprises:

acquiring step count and sleep information of the user via a fitness step counting unit; and

displaying step count and sleep information acquired by the fitness step counting unit.

Optionally, the method further comprises:

communicating with an external electronic device in accordance with a predetermined communication protocol, so as to transfer the acquired step count and sleep information to the external electronic device, thus realizing information synchronization.

According to another embodiment of the present disclosure, there is provided a wearable device for identifying biological features, comprising:

a sensor configured to detect biological features of an object to be detected;

a memory;

a processor;

the sensor, the memory, and the processor are connected to each other;

the biological features at least include finger vein information;

the memory being configured to store computer readable instructions to control the processor to:

acquire the biological features detected by the sensor;

perform predetermined image processing on the biological features to extract feature information of the biological features; and

compare the extracted feature information with pre-stored feature information.

Optionally, the processor is further configured to:

perform a payment transaction operation according to a predetermined operation when the user is identified as an authorized user.

Therefore, the wearable device and the information processing method according to the embodiments of the present disclosure enable safe and reliable payment while realizing easy and convenient portability.

### BRIEF DESCRIPTION OF THE DRAWINGS

FIG. 1 is a block diagram illustrating functional configuration of a wearable device according to a first embodiment of the present application;

FIG. 2 is a block diagram illustrating structure of the wearable device according to the first embodiment of the present application;

FIG. 3 is a structural diagram illustrating a first example of a biometric image acquiring unit;

FIG. 4 is a structural diagram illustrating a second example of the biometric image acquiring unit;

FIG. 5 is a block diagram illustrating functional configuration of a wearable device according to a second embodiment of the present application;

FIG. 6 is a flowchart illustrating an information processing method according to a third embodiment of the present application;

FIG. 7 is a flowchart illustrating an information processing method according to a fourth embodiment of the present application;

FIG. 8 is a flowchart illustrating an information processing method according to a fifth embodiment of the present application;

FIG. 9 is a block diagram illustrating configuration of a wearable device according to a sixth embodiment of the present application; and

FIG. 10 is a flowchart illustrating an information processing method according to a seventh embodiment of the present application.

### DETAILED DESCRIPTION OF THE EMBODIMENTS

Hereinafter, the wearable device and the information processing method according to the embodiments of the present application will be described in detail with reference to the accompanying drawings.

The information processing method according to an embodiment of the present application may be applied to a wearable device, such as smart watch, smart phone and so on. The following description in the embodiments is provided with the smart watch as an example.

### First Embodiment

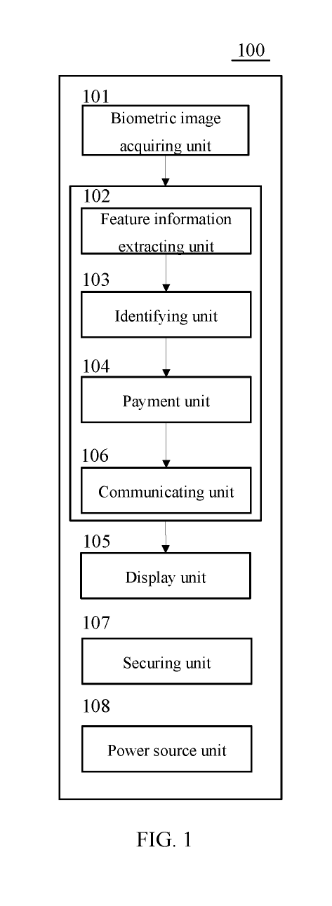

A wearable device according to a first embodiment of the present application will be described in detail below with reference to FIGS. 1 to 3. In this embodiment, a smart watch will be described as an example.

FIG. 1 is a block diagram illustrating functional configuration of a wearable device according to a first embodiment of the present application. As shown in FIG. 1, the wearable device 100 according to the first embodiment of the present application comprises:

a biometric image acquiring unit 101 configured to acquire a biometric image of predetermined biological features of a user;

a feature information extracting unit 102 configured to perform predetermined image processing on the acquired biometric image to extract feature information of predetermined biological features of the user; and

an identifying unit 103 configured to compare the extracted feature information of predetermined biological features of the user with pre-stored feature information to identify whether the user is an authorized user.

The predetermined biological features of the user may be the user's fingers, fingerprint, face etc., as long as the biological features have uniqueness and can uniquely identify the user.

In this embodiment, description will be provided with predetermined biological features being the user's fingers as an example. Thus, the biometric image acquiring unit 101 may be configured to acquire a finger vein image of a predetermined finger of the user.

Finger vein technology has a number of important characteristics that make itself superior to other biometric technology in terms of safety and convenience. The following are main reflection aspects:

high anti-counterfeiting: vein is hidden in a physical body, it is difficult to copy or misappropriate;

easy to use: basically not affected by physical and environmental factors, such as skin dryness/humidness, oil, dust, skin surface abnormality etc.;

high accuracy: false accept rate of 0.0001%, false rejection rate of 0.01%, registration failure rate of 0%;

rapid identification: an original finger vein image is captured and digitized, image contrast is implemented by mature finger vein extraction algorithms, the whole process is less than one second.

As shown in FIG. 1, the wearable device 100 may also comprise a payment unit 104 configured to perform a payment transaction operation according to a predetermined operation when the user is identified as an authorized user.

In an embodiment, the wearable device 100 may also comprise a display unit 105 configured to display step count and sleep information acquired by the fitness step counting unit.

In addition, in another embodiment, the wearable device 100 may also comprise a communicating unit 106 configured to communicate with an external electronic device in accordance with a predetermined communication protocol, so as to transfer the acquired step count and sleep information to the external electronic device, thus realizing information synchronization.

As shown in FIG. 1, the wearable device 100 may also comprise a securing unit 107 configured to secure relative positional relationship between the electronic device and the user. In addition, the wearable device 100 may also comprise a power source unit 108 configured to include a flexible battery and be integrated into the securing unit.

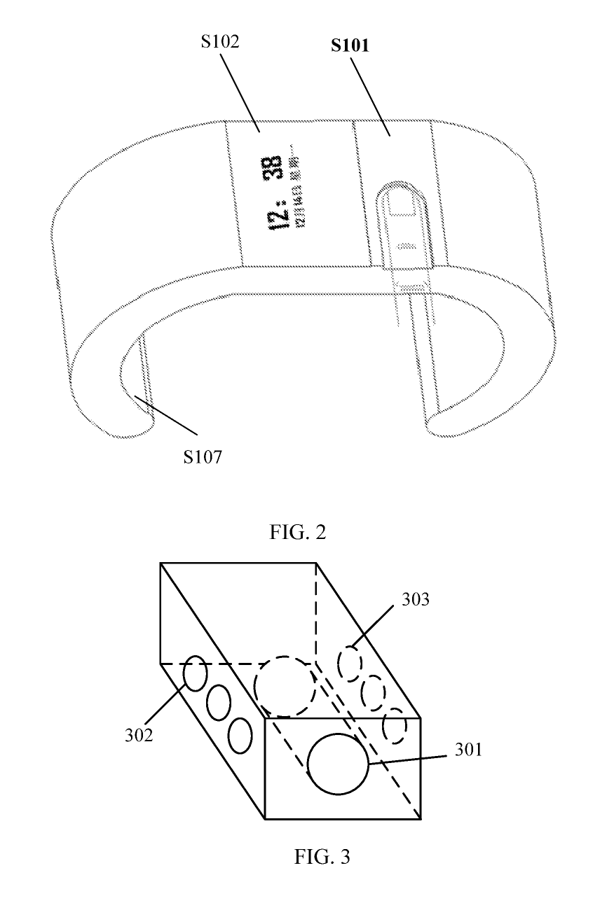

As shown in FIG. 2, the wearable device 100 may comprise a main body portion and a securing portion.

The main body portion may comprise, for example, the biometric image acquiring unit 101 and the display unit 105. It should be noted that other units not shown in FIG. 2 may be disposed in the area below the biometric image acquiring unit 101 and the display unit 105. For example, in this area, a circuit board may be disposed for setting various circuit components such as a processor, a memory, a sensor, and a communication module.

The securing portion may be, for example, the securing unit 107 shown in FIG. 1. The securing unit 107 may secure relative positional relationship between the wearable device 100 and the user. For example, in this embodiment, the securing unit 107 may secure the wearable device 100 on the wrist of the user.

In the case where the wearable device is glasses, the securing unit 107 may secure the wearable device 100 to the user's head.

Next, structure of the biometric image acquiring unit will be described in detail with reference to FIG. 3. As shown in FIG. 3, the biometric image acquiring unit 101 comprises:

an accommodating sub-unit 301 configured to accommodate a predetermined finger of the user;

an infrared light source sub-unit 302 configured to emit infrared light to illuminate the predetermined finger of the user as accommodated in the accommodating sub-unit; and

an image sensor sub-unit 303 configured to receive infrared light that has illuminated the predetermined finger of the user and passed through, thereby generate a finger vein image of the predetermined finger of the user;

In this embodiment, the receiving sub-unit 301 may have a fixed predetermined depth and a fixed predetermined width, said depth and width are suitable for an adult's finger.

In addition, as shown in FIG. 3, the infrared light source sub-unit 302 is disposed on a first side in a horizontal direction of the accommodating sub-unit 301, and the image sensor sub-unit 303 is disposed on a second side opposite to the first side in a horizontal direction of the accommodating sub-unit 301.

In this embodiment, in consideration of thickness of the entire wearable device 100, the infrared light source sub-unit 302 and the image sensor sub-unit 303 are provided separately on two sides of the accommodating unit 301 in the horizontal direction so as to reduce thickness of the wearable device 100 in the vertical direction.

According to characteristics of human body tissue, the infrared light source sub-unit 302 can select infrared light having a wavelength of 0.72 to 1.10 um as the irradiation light source, so that a vein map of the finger can be well obtained. The wavelength belongs to near infrared light.

The infrared light source sub-unit 302 uses infrared LED to emit infrared light and illuminate from a first side of the groove of the accumulating unit 301, and after the infrared light passes through the user's finger accumulated in the groove of the accumulating unit 301, the image sensor sub-unit 303 disposed on the other side of the groove of the accumulating unit 301 can image by using infrared light that has passed through the finger to obtain a vein map of the finger. The image sensor sub-unit 303 then transmits the acquired vein map to the feature information extracting unit 102.

The feature information extracting unit 102 performs predetermined image processing on the acquired finger vein image to extract feature information of finger vein of the user. In particular, feature extraction may be performed on the digital image by using advanced filtering, image binarization, refinement measures. Such finger vein extraction algorithms are well known to those skilled in the art, and detailed description thereof is omitted here.

The identifying unit 103 then compares the extracted feature information of finger vein of the user with pre-stored feature information to identify whether the user is an authorized user.

Specifically, feature information of finger vein of authorized users may be stored in a memory in advance, then the identifying unit 103 uses a matching algorithm to match the extracted finger vein feature from the feature information extracting unit 102 with the stored feature information of authorized users. When a match result indicates that the extracted finger vein feature from the feature information extracting unit 102 matches with pre-stored feature information of an authorized user, it is determined that the current user is an authorized user.

It is to be noted that vein eigenvalues of multiple users may be stored according to a size of storage space of the wearable device 100 to support multi-user secure smart payment and information query.

In this embodiment, the feature information extracting unit 102 and the identifying unit 103 may be realized by, for example, a processor circuit. That is, the feature information extracting unit 102 and the identifying unit 103 may be, for example, sub-circuits in the processor circuit.

The processor circuit may be a composition of one or several ones of commonly used processors, such as ARM, MCU, DSP, POWERPC and others. The processor circuit mainly performs communication with other units and controls the other units, and also performs image processing on the finger vein information and extracts eigenvalues to complete matching, and so on.

When the user is identified as an authorized user, the payment unit 104 may perform a payment transaction operation according to a predetermined operation.

Specifically, for example, when the user enables a payment via a predetermined application, it is possible to prompt the user to perform vein image acquisition when a password is requested. When the user's vein feature conforms to pre-stored eigenvalues of an authorized user, the payment transaction operation may be performed by the payment unit 104. That is, vein image acquisition matches the user's vein information eigenvalues, which is just like password input, and thereby completes payment.

The smart wearable device 100 may complete a contactless payment via the payment unit 104. For example, the payment unit 104 of the wearable device 100 may select an SD card scheme, an SIM card scheme, or a full terminal scheme. Selection of the SD card scheme or the SIM card scheme requires setting a card slot in a finger strap, used to place the SD or SIM card. The full terminal scheme does not require setting a card slot additionally.

In addition, in the wearable device 100 according to this embodiment, in order to reduce thickness, the power source unit 108 is configured to include a flexible battery and integrated into the securing unit 107, for supplying power to the entire device.

Specifically, since the battery of the smart wearable device occupies a large space, and when the finger vein image acquiring circuit is added, a volume of the entire wearable device 100 will be very large, which makes the wearable device difficult to wear. Thus, in the wearable device 100 according to this embodiment, a flexible battery is used in place of the conventional lithium polymer battery and the flexible battery is integrated into the securing unit such as a wristband of the wearable payment device, as a result, the battery does not occupy any space on the motherboard of the wearable payment device, and supplies power to the motherboard portion via a connector. In addition, the wearable device 100 according to this embodiment can also use a highly integrated CPU chip integrated with the communicating unit such as WiFi, Bluetooth etc., the smart wearable payment device can be miniaturized to be portable by adopting a high density PCB design.

In addition, the display unit 105 may be connected to the processor to realize image displaying of the wearable device 100. The display unit 105 may include a driver chip and common screens such as an LED screen, an LCD panel etc. Besides, it may be a built-in display driver inside the processor, the display unit 105 includes only a common display screen.

Therefore, the wearable device according to this embodiment of the present application can perform personal identification by using the user's finger vein image information as feature information of identity authentication. It not only can achieve an easy and convenient payment as that in an existing payment device, but also can achieve a safer large payment that cannot be achieved by a general payment device. Even if said device is lost, money inside the device cannot be stolen. It enables safe and reliable payment while realizing easy and convenient portability.

Besides, the wearable device according to this embodiment of the present application is designed with ingenious structure and highly optimized circuit, the volume of the device is minimized by proprietary algorithms, so that vein image acquisition can be applied to a wearable payment device.

### Second Embodiment

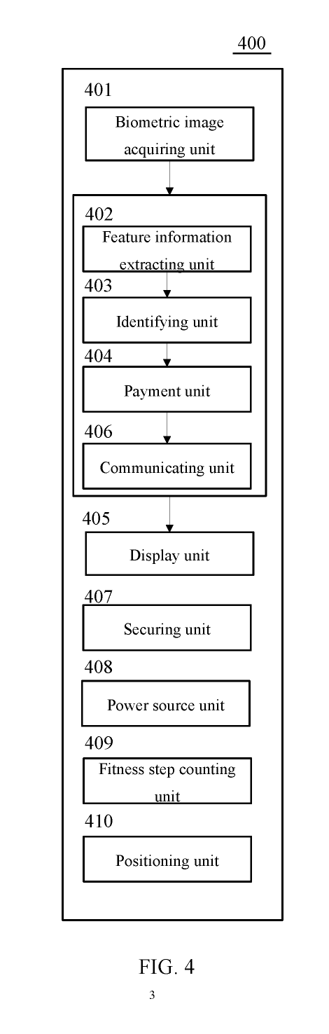

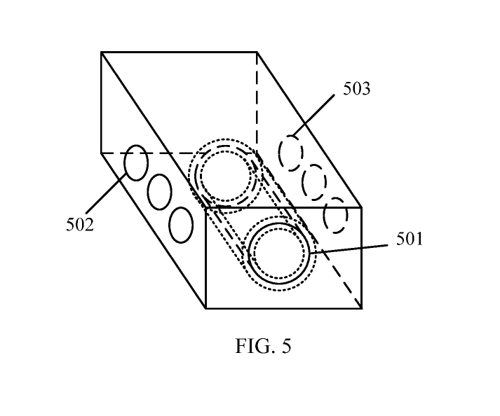

Hereinafter, a wearable device according to a second embodiment of the present application will be described in detail below with reference to FIGS. 4 to 5. In this embodiment, a smart watch will be described as an example.

FIG. 4 is a structural diagram illustrating a second example of the biometric image acquiring unit. As shown in FIG. 4, the wearable device 400 according to the second embodiment of the present application comprises a biometric image acquiring unit 401, a feature information extracting unit 402, an identifying unit 403, a payment unit 404, a display unit 405, a communicating unit 406, a power source unit 407, a securing unit 408, a fitness step counting unit 409, and a positioning unit 410.

The feature information extracting unit 402, the identifying unit 403, the payment unit 404, the display unit 405, the communicating unit 406, the power source unit 407, the securing unit 408 in the wearable device 400 according to the second embodiment of the present application are basically the same as the feature information extracting unit 102, the identifying unit 103, the payment unit 104, the display unit 105, the communicating unit 106, the power source unit 107, the securing unit 108 in the wearable device 100 according to the first embodiment of the present application, and detailed description thereof is omitted here.

The biometric image acquiring unit 401, the fitness step counting unit 409, and the positioning unit 410 different from the wearable device 100 according to the first embodiment will be mainly described below.

Structure of the biometric image acquiring unit will be described in detail below with reference to FIG. 5. As shown in FIG. 5, the biometric image acquiring unit 401 comprises:

an accommodating sub-unit 501 configured to accommodate a predetermined finger of the user;

an infrared light source sub-unit 502 configured to emit infrared light to illuminate the predetermined finger of the user as accommodated in the accommodating sub-unit;

an image sensor sub-unit 503 configured to receive infrared light that has illuminated the predetermined finger of the user and passed through, thereby generate a finger vein image of the predetermined finger of the user.

In this embodiment, the receiving sub-unit 501 may have a fixed predetermined depth and a fixed predetermined width, said depth and width are suitable for an adult's finger.

In addition, the accommodating sub-unit 501 is configured to detect a shape of the accommodated predetermined finger of the user, and adjust the predetermined depth and the predetermined width according to the shape detected for the predetermined finger of the user.

Specifically, for example, when the user's index finger is not convenient for vein image identification due to an injury or the like, the user may choose to use other fingers such as a middle finger or a ring finger. Since thickness and length of each finger are different, it is necessary to adjust depth and width of the accommodating sub-unit 501 so as to fit the user's finger as much as possible, thereby a better finger vein image can be acquired.

Alternatively, when the wearable device is used for multiple users, thickness and length of each user's finger are different, so depth and width of the accommodating sub-unit 501 need to be adjusted so as to fit the fingers of different users as much as possible, thereby a better finger vein image can be acquired.

In addition, as shown in FIG. 5, the infrared light source sub-unit 502 is disposed on a first side in a horizontal direction of the accommodating sub-unit 501, and the image sensor sub-unit 503 is disposed on a second side opposite to the first side in a horizontal direction of the accommodating sub-unit 501.

In this embodiment, in consideration of thickness of the entire wearable device 100, the infrared light source sub-unit 502 and the image sensor sub-unit 503 are provided separately on two sides of the accommodating unit 301 in the horizontal direction so as to reduce thickness of the wearable device 100 in the vertical direction.

In addition, in the wearable device 400 according to this embodiment, the wearable device 400 further comprises a fitness step counting unit 409 configured to acquire the user's step count and sleep information.

For example, the fitness step counting unit 409 acquires human body information through change in the gravity acceleration, and acquires human's step count and sleep information via algorithms In addition, the fitness step counting unit 409 may transfer the acquired information to the processor.

In addition, the communicating unit 406 may communicate with an external electronic device in accordance with a predetermined communication protocol, so as to transfer the acquired step count and sleep information to the external electronic device, thus realizing information synchronization. For example, consumption information and the step count and sleep information of said device may also be transferred to a handset application via a communication module such as Bluetooth, WiFi etc., thus realizing information synchronization.

In addition, the display unit 405 may also display the step count and sleep information acquired by the fitness step counting unit 409.

In addition, in the wearable device 400 according to this embodiment, the wearable device 400 further comprises the positioning unit 410. The positioning unit 410 may include positioning functions such as a GPS, BeiDou Navigation Satellite System (BDS) etc., so the wearable device 400 expands more functions to provide better using experience to the user.

Therefore, the wearable device according to this embodiment of the present application can perform personal identification by using the user's finger vein image information as feature information of identity authentication. It not only can achieve an easy and convenient payment as that in an existing payment device, but also can achieve a safer large payment that cannot be achieved by a general payment device. Even if said device is lost, money inside the device cannot be stolen. It enables safe and reliable payment while realizing easy and convenient portability.

Besides, the wearable device according to this embodiment of the present application is designed with ingenious structure and highly optimized circuit, the volume of the device is minimized by proprietary algorithms, so that vein image acquisition can be applied to a wearable payment device. In addition, the wearable device according to the embodiment of the present application can provide the user with more functions by providing a fitness step counting unit, a positioning unit, etc., thereby providing a better user experience.

Furthermore, the wearable device according to this embodiment of the present application provides the fitness step count unit and the positioning unit, which can offer the user with more functions, thus providing a better user experience.

### Third Embodiment

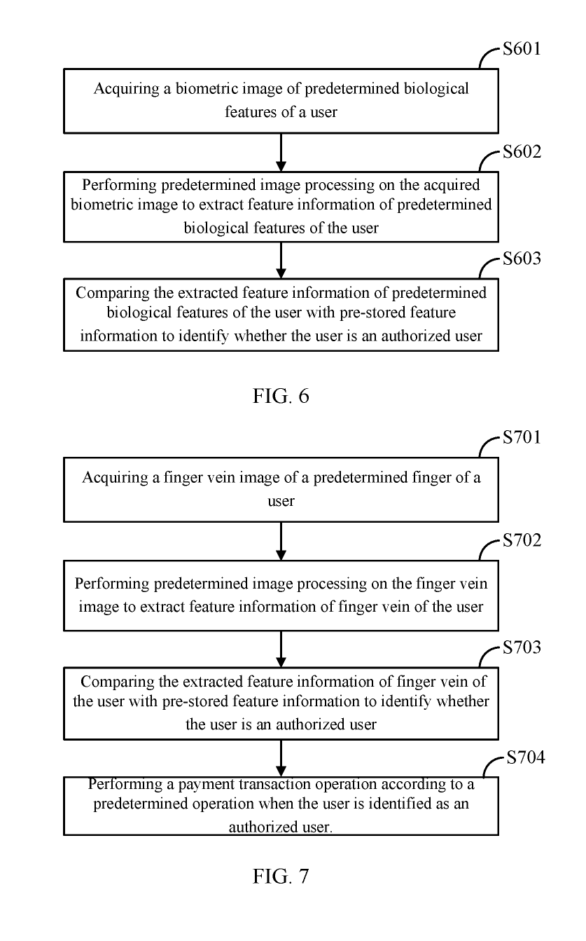

Hereinafter, an information processing method according to a third embodiment of the present application will be described with reference to FIG. 6. The information processing method can be applied to, for example, the wearable device in the above-described first and second embodiments.

As shown in FIG. 6, the information processing method 600 according to the third embodiment of the present application comprises:

S601: acquiring a biometric image of predetermined biological features of a user;

S602: performing predetermined image processing on the acquired biometric image to extract feature information of predetermined biological features of the user; and

S603: comparing the extracted feature information of predetermined biological features of the user with pre-stored feature information to identify whether the user is an authorized user.

The predetermined biological features of the user may be the user's fingers, fingerprint, face etc., as long as the biological features have uniqueness and can uniquely identify the user.

In this embodiment, description will be provided with predetermined biological features being the user's fingers as an example. Thus, the biometric image acquiring unit 101 may be configured to acquire a finger vein image of a predetermined finger of the user.

Specifically, in step S601, when the user puts his/her finger into the accommodating sub-unit, the finger vein image of the user's predetermined finger can be acquired.

Thereafter, in step S602, predetermined image processing may be performed on the acquired biometric image to extract feature information of predetermined biological features of the user. For example, feature extraction may be performed on the digital image by using advanced filtering, image binarization, refinement measures. Such finger vein extraction algorithms are well known to those skilled in the art, and detailed description thereof is omitted here.

Then, in step S603, the extracted feature information of finger vein of the user is compared with pre-stored feature information to identify whether the user is an authorized user. Specifically, feature information of finger vein of authorized users may be stored in a memory in advance, then a matching algorithm is used to match the extracted finger vein feature with the stored feature information of authorized users. When a match result indicates that the extracted finger vein feature matches with pre-stored feature information of an authorized user, it is determined that the current user is an authorized user.

After determining that the user is an authorized user, the wearable device allows the user to perform subsequent operations. For example, after the wearable device locks its screen, the display screen of the wearable device is allowed to be lightened after the user is determined as an authorized user. For example, when the wearable device is turned off, the wearable device may be allowed to be turned on after the user is determined as an authorized user.

In this way, the information processing method according to this embodiment of the present application can perform personal identification by using the user's finger vein image information as feature information of identity authentication, identity authentication of the user can be performed more precisely.

### Fourth Embodiment

Hereinafter, an information processing method according to a fourth embodiment of the present application will be described with reference to FIG. 7. In this embodiment, description will be provided with predetermined biological features being the user's fingers as an example. As shown in FIG. 7, the information processing method 700 according to the fourth embodiment of the present application comprises:

S701: acquiring a finger vein image of a predetermined finger of a user;

S702: performing predetermined image processing on the finger vein image to extract feature information of finger vein of the user;

S703: comparing the extracted feature information of finger vein of the user with pre-stored feature information to identify whether the user is an authorized user; and

S704: performing a payment transaction operation according to a predetermined operation when the user is identified as an authorized user.

Specifically, in step S701, when the user puts his/her finger into the accommodating sub-unit, the finger vein image of the user's predetermined finger can be acquired.

Thereafter, in step S702, predetermined image processing may be performed on the acquired finger vein image to extract feature information of finger vein of the user. For example, feature extraction may be performed on the digital image by using advanced filtering, image binarization, refinement measures. Such finger vein extraction algorithms are well known to those skilled in the art, and detailed description thereof is omitted here.

Then, in step S703, the extracted feature information of finger vein of the user is compared with pre-stored feature information to identify whether the user is an authorized user. Specifically, feature information of finger vein of authorized users may be stored in a memory in advance, then a matching algorithm is used to match the extracted finger vein feature with the stored feature information of authorized users. When a match result indicates that the extracted finger vein feature matches with pre-stored feature information of an authorized user, it is determined that the current user is an authorized user.

In step S704, only after determining that the user is an authorized user, the wearable device allows the user to perform a payment transaction operation according to a predetermined operation.

For example, when a user opens a payment transaction through a predetermined application, the user may be prompted to acquire a vein image when a password is requested. When the user puts his/her finger into the accommodating sub-unit, and the extracted vein feature conforms to pre-stored eigenvalues of an authorized user, the payment transaction operation may be performed by the payment unit. That is, vein image acquisition matches the user's vein information eigenvalues, which is just like password input, and thereby completes payment.

In this way, personal identification can be performed by using the user's finger vein image information as feature information of identity authentication, identity authentication of the user can be performed more precisely.

Therefore, the information processing method according to this embodiment of the present application can perform personal identification by using the user's finger vein image information as feature information of identity authentication. It not only can achieve an easy and convenient payment as that in an existing payment device, but also can achieve a safer large payment that cannot be achieved by a general payment device. Even if said device is lost, money inside the device cannot be stolen. It enables safe and reliable payment while realizing easy and convenient portability.

### Fifth Embodiment

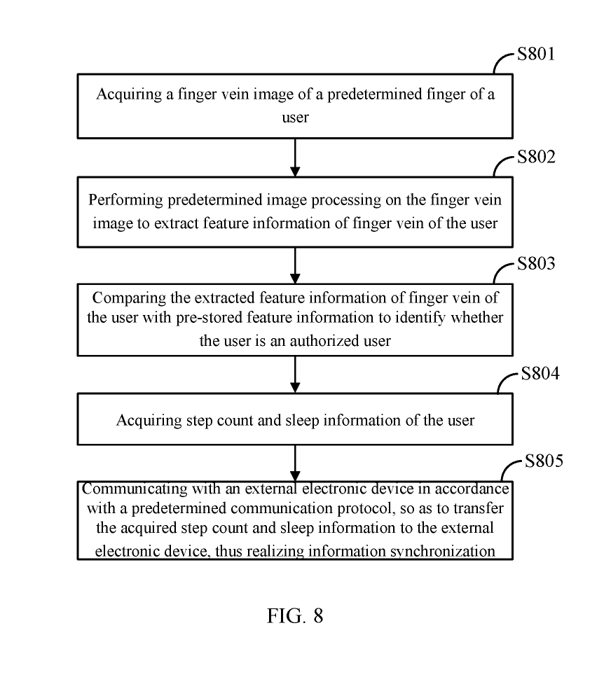

Hereinafter, an information processing method according to a fifth embodiment of the present application will be described with reference to FIG. 8. In this embodiment, description will be provided with predetermined biological features being the user's fingers as an example. As shown in FIG. 8, the information processing method 800 according to the fourth embodiment of the present application comprises:

S801: acquiring a finger vein image of a predetermined finger of a user;

S802: performing predetermined image processing on the finger vein image to extract feature information of finger vein of the user;

S803: comparing the extracted feature information of finger vein of the user with pre-stored feature information to identify whether the user is an authorized user; and

S804: acquiring step count and sleep information of the user; and

S805: communicating with an external electronic device in accordance with a predetermined communication protocol, so as to transfer the acquired step count and sleep information to the external electronic device, thus realizing information synchronization.

Specifically, in step S801, when the user puts his/her finger into the accommodating sub-unit, the finger vein image of the user's predetermined finger can be acquired.

Thereafter, in step S802, predetermined image processing may be performed on the acquired finger vein image to extract feature information of finger vein of the user. For example, feature extraction may be performed on the digital image by using advanced filtering, image binarization, refinement measures. Such finger vein extraction algorithms are well known to those skilled in the art, and detailed description thereof is omitted here.

Then, in step S803, the extracted feature information of finger vein of the user is compared with pre-stored feature information to identify whether the user is an authorized user. Specifically, feature information of finger vein of authorized users may be stored in a memory in advance, then a matching algorithm is used to match the extracted finger vein feature with the stored feature information of authorized users. When a match result indicates that the extracted finger vein feature matches with pre-stored feature information of an authorized user, it is determined that the current user is an authorized user.

Thereafter, in step S804, step count and sleep information of the user is acquired. For example, step count and sleep information of the user may be acquired via a fitness step counting sensor.

Last, in step S805, communication with an external electronic device may be performed in accordance with a predetermined communication protocol, so as to transfer the acquired step count and sleep information to the external electronic device, thus realizing information synchronization. For example, consumption information and the step count and sleep information of the device may also be transferred to a handset application via a communication module such as Bluetooth, WiFi etc., thus realizing information synchronization.

Therefore, the information processing method according to this embodiment of the present application can, by means of acquiring various information of the user such as step count and sleep information by using the fitness step counting unit, offer the user with more functions, thereby provide the user with better using experience,

### Sixth Embodiment

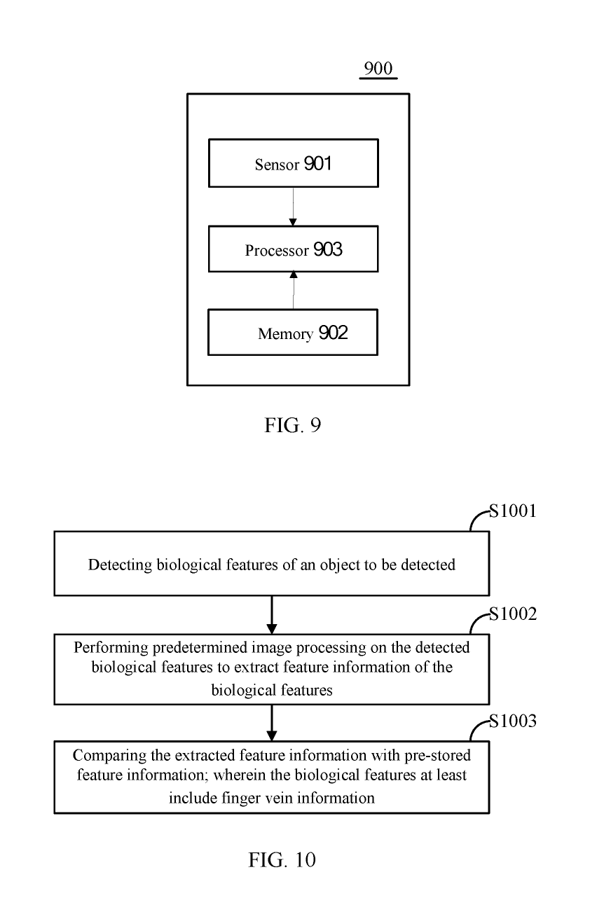

FIG. 9 is a block diagram illustrating configuration of a wearable device according to a sixth embodiment of the present application.

As shown in FIG. 9, the wearable device 900 comprises:

a sensor 901 configured to acquire a biometric image of predetermined biological features of a user;

a memory 902 configured to store the biometric image and computer-executable instructions;

a processor 903 configured to execute computer-executable instructions stored in the memory to perform the following operations:

performing predetermined image processing on the acquired biometric image to extract feature information of predetermined biological features of the user; and

comparing the extracted feature information of predetermined biological features of the user with pre-stored feature information to identify whether the user is an authorized user.

Optionally, the processor 903 is further configured to:

perform a payment transaction operation according to a predetermined operation when the user is identified as an authorized user.

The sensor 901 may be, for example, the biometric image acquiring unit 101 in FIG. 1 or the biometric image acquiring unit 401 in FIG. 4, the sensor 901 is for detecting biological features of an object to be detected, and the biological features include at least finger vein information.

The sensor 901, the memory 902, and the processor 903 are connected to each other. The memory is configured to store computer readable instructions to control the processor to:

acquire the biological features detected by the sensor;

perform predetermined image processing on the biological features to extract feature information of the biological features; and

compare the extracted feature information with pre-stored feature information.

That is to say, the processor 903 implements, for example, the feature information extracting unit 102 and the identifying unit 103 in FIG. 1; besides, the processor 903 implements, for example, the feature information extracting unit 402 and the identifying unit 403 in FIG. 4.

Optionally, the sensor 901 comprises:

an accommodating space configured to place the object to be detected; the accommodating space corresponds to, for example, the accommodating sub-unit 301 in FIG. 3 or the accommodating sub-unit 501 in FIG. 5;

an infrared light source configured to emit infrared light to illuminate the object to be measured in the accommodating space; the infrared light source corresponds to, for example, the infrared light source sub-unit 302 in FIG. 3 or the infrared light source sub-unit 502 in FIG. 5; and an image sensor configured to receive infrared light that has passed through the object to be detected, thereby generate a finger vein image of the object to be detected; the image sensor corresponds to, for example, the infrared light source sub-unit 303 in FIG. 3 or the infrared light source sub-unit 503 in FIG. 5.

Optionally, the infrared light source is disposed on a first side of the accommodating space, and the image sensor is disposed on a second side opposite to the first side of the accommodating space.

Optionally, the accommodating space includes a groove. The groove corresponds, for example, the groove of the accommodating sub-unit 301 in FIG. 3 or the groove of the accommodating sub-unit 501 in FIG. 5.

Optionally, the wearable device further comprises a main framework and a securing structure, the main framework is connected to the securing structure, and the securing structure is used to fix the main framework to a specific position. The main framework corresponds to the main body portion in the first embodiment or the second embodiment. The securing structure corresponds to the securing unit 107 in FIG. 1 or the securing unit 407 in FIG. 4.

Optionally, the sensor 901, the memory 902, and the processor 903 are all disposed on the main framework.

Optionally, the wearable device further comprises a power source, the power source is disposed on the securing structure. The power source corresponds to, for example, the power source unit 108 in FIG. 1 or the power source unit 408 in FIG. 4.

Optionally, the power source comprises a flexible battery.

Optionally, the processor 903 is configured to:

perform a payment operation when the extracted feature information matches with the pre-stored feature information. That is, the processor 903 implements, for example, the payment unit 104 in FIG. 1 or the payment unit 404 in FIG. 4.

Optionally, the processor 903 is configured to acquire step count and sleep information for a user of the wearable device.

Optionally, the wearable device further comprises a display screen configured to display the acquired step count and sleep information. The display screen corresponds to, for example, the display unit 105 in FIG. 1 or the display unit 405 in FIG. 5.

Optionally, the processor 903 is further configured to communicate with an external electronic device in accordance with a predetermined communication protocol, so as to transfer the acquired step count and sleep information to the external electronic device, thus realizing information synchronization. That is, the processor 903 implements, for example, the communicating unit 106 in FIG. 1 or the communicating unit 406 in FIG. 4.

Therefore, the wearable device according to this embodiment of the present application enables safe and reliable payment while realizing easy and convenient portability.

### Seventh Embodiment

Hereinafter, an information processing method according to a seventh embodiment of the present application will be described with reference to FIG. 10. In this embodiment, description will be provided with predetermined biological features being the user's fingers as an example. As shown in FIG. 10, the information processing method according to the seventh embodiment of the present application comprises:

S1001: detecting biological features of an object to be detected;

S1002: performing predetermined image processing on the detected biological features to extract feature information of the biological features;

S1003: comparing the extracted feature information with pre-stored feature information;

wherein the biological features at least include finger vein information.

Optionally, detecting biological features of an object to be detected comprises:

placing the object to be detected in an accommodating space of the wearable device;

using infrared light to illuminate the object to be detected in the accommodating space; and

receiving the infrared light that has passed through the object to be detected, thereby generating a finger vein image of the object to be detected.

Optionally, the accommodating space includes a groove.

Optionally, the predetermined image processing includes image grayscale normalization, image enhancement, image segmentation, image de-noising, image refinement.

Optionally, an approach of comparing the extracted feature information with pre-stored feature information includes a two-dimensional linear analysis identification algorithm.

Optionally, the method further comprises:

performing a payment operation when the extracted feature information matches with the pre-stored feature information.

Optionally, the method further comprises:

acquiring step count and sleep information for a user of the wearable device; and

displaying the acquired step count and sleep information.

Optionally, the method further comprises:

communicating with an external electronic device in accordance with a predetermined communication protocol, so as to transfer the acquired step count and sleep information to the external electronic device, thus realizing information synchronization.

Therefore, the information processing method according to this embodiment of the present application can, by means of acquiring various information of the user such as step count and sleep information, offer the user with more functions, thereby provide the user with better using experience.

It is to be noted that the above embodiments are merely examples, and the present application is not limited to such examples, various changes may be made.

It should be noted that, in the specification, the terms “comprise”, “include” and any other variations thereof intend to cover nonexclusive inclusion so that the procedure, the method, the product or the equipment including a series of elements include not only these elements, but also other elements which are not listed explicitly, or also include inherent elements of these procedure, method, product or equipment. In the case that there is no further limitation, elements defined by the expressions “comprise one . . . ” do not exclude there being additional identity elements in the procedure, method, product or equipment of the elements.

Finally, it should be noted that, the above-described series of processes do not only comprise processes executed chronologically in the order mentioned here, and also comprise processes executed in parallel or individually but not chronologically.

Through the above description of the implementations, a person skilled in the art can clearly understand that the present application may be implemented in a manner of software plus a necessary hardware platform, and of course the present application may also be implemented fully by hardware. Based on such understanding, the technical solution of the present application that contributes to the background art may be embodied in whole or in part in the form of a software product. The computer software product may be stored in a storage medium, such as ROM/RAM, disk, CD-ROM, and include several instructions for causing a computer apparatus (which may be a personal computer, a server, or a network device) to perform the method described in the various embodiments of the present application or certain parts thereof.

Although the present application has been described in detail in the above, specific examples are applied in this text to demonstrate the principles and implementations of the present application, these descriptions of the above embodiments are only to help understand the method of the present application and its core concept. Meanwhile, for a person with ordinary skill in the art, depending on the concepts of the present application, modifications may be made to the specific implementations and applications. To sum up, contents of this specification should not be construed as limiting the present application.

The present application claims priority of the Chinese Patent Application No. 201610324320.1 filed on May 16, 2016, the entire application of which is hereby incorporated in full text by reference as part of the present application.

What is claimed is:

1. A wearable device for identifying biological features, comprising:
a sensor configured to detect biological features of an object to be detected;
a memory;
a processor;
the sensor, the memory, and the processor are connected to each other;
the biological features at least include finger vein information;
the memory is configured to store computer readable instructions to control the processor to:
acquire the biological features detected by the sensor;
perform predetermined image processing on the biological features to extract feature information of the biological features; and
compare the extracted feature information with pre-stored feature information.

2. The wearable device as claimed in claim 1, wherein the sensor comprises:
an accommodating space configured to place the object to be detected;
an infrared light source configured to emit infrared light to illuminate the object to be detected in the accommodating space; and
an image sensor configured to receive infrared light that has passed through the object to be detected, thereby generate a finger vein image of the object to be detected.

3. The wearable device as claimed in claim 2, wherein the infrared light source is disposed on a first side of the accommodating space, and the image sensor is disposed on a second side opposite to the first side of the accommodating space.

4. The wearable device as claimed in claim 3, wherein the accommodating space includes a groove.

5. The wearable device as claimed in claim 1, further comprising a main framework and a securing structure, the main framework being connected to the securing structure, and the securing structure being configured to fix the main framework to a specific position.

6. The wearable device as claimed in claim 5, wherein the sensor, the memory, and the processor are all disposed on the main framework.

7. The wearable device as claimed in claim 6, further comprising a power source disposed on the securing structure.

8. The wearable device as claimed in claim 7, wherein the power source includes a flexible battery.

9. The wearable device as claimed in claim 1, wherein the processor is configured to:
perform a payment operation when the extracted feature information matches with the pre-stored feature information.

10. The wearable device as claimed in claim 1, wherein the processor is configured to acquire step count and sleep information for a user of the wearable device.

11. The wearable device as claimed in claim 10, further comprising a display screen configured to display the acquired step count and sleep information.

12. The wearable device as claimed in claim 10, wherein the processor is further configured to communicate with an external electronic device in accordance with a predetermined communication protocol, so as to transfer the acquired step count and sleep information to the external electronic device, thus realizing information synchronization.

13. A method of identifying biological features, the method being applicable to a wearable device, the method comprising:
detecting biological features of an object to be detected;
performing predetermined image processing on the detected biological features to extract feature information of the biological features;
comparing the extracted feature information with pre-stored feature information;
wherein the biological features at least include finger vein information.

14. The method as claimed in claim 13, wherein detecting biological features of an object to be detected comprises:
placing the object to be detected in an accommodating space of the wearable device;
using infrared light to illuminate the object to be detected in the accommodating space; and
receiving the infrared light that has passed through the object to be detected, thereby generating a finger vein image of the object to be detected.

15. The method as claimed in claim 14, wherein the accommodating space includes a groove.

16. The method as claimed in claim 13, wherein the predetermined image processing includes image grayscale normalization, image enhancement, image segmentation, image de-noising, image refinement.

17. The method as claimed in claim 13, an approach of comparing the extracted feature information with pre-stored feature information includes a two-dimensional linear analysis identification algorithm.

18. The method as claimed in claim 13, further comprising:
performing a payment operation when the extracted feature information matches with the pre-stored feature information.

19. The method as claimed in claim 13, further comprising:
acquiring step count and sleep information for a user of the wearable device; and
displaying the acquired step count and sleep information.

20. The method as claimed in claim 19, further comprising:
communicating with an external electronic device in accordance with a predetermined communication protocol, so as to transfer the acquired step count and sleep information to the external electronic device, thus realizing information synchronization.
